(19) United States
(12) Patent Application Publication
(10) Pub. No.: US 2013/0083901 A1
(43) Pub. Date: Apr. 4, 2013

(54) METHOD AND DEVICE FOR DETERMINING THE WEAR OF AN X-RAY ANODE

(71) Applicant: Michael Grasruck, Nuemberg (DE)

(72) Inventor: Michael Grasruck, Nuemberg (DE)

(21) Appl. No.: 13/631,987

(22) Filed: Sep. 29, 2012

(30) Foreign Application Priority Data
Sep. 29, 2011 (DE) DE 102011083729.9

(51) Int. Cl. G01T 1/16; G01T 1/36

(52) U.S. Cl. 378/207

(57) ABSTRACT

A method and a device for determining the wear of an X-ray anode having an anode plate are provided. The method includes determining a reference value for a parameter that characterizes a property influenced by the dependence of an angle between radiation generated by the X-ray anode and the anode plate. The method also includes determining a value for the parameter after a specific operating time. The wear is established by comparing the determined value for the parameter with the reference value and correlating a deviation of the determined value for the parameter from the reference value with a wear state of the X-ray anode.

This application claims the benefit of DE 10 2011 083 729.9, filed on Sep. 29, 2011.

### BACKGROUND

The present embodiments relate to a method and a device for determining the wear of an X-ray anode.

X-ray beams have a widespread spectrum of application including, for example, materials testing to medical use for diagnosis and therapy. Devices referred to as X-ray tubes may be used for generating X-ray beams. These X-ray tubes are formed with an anode and a cathode. Free electrons are produced by heating the cathode and accelerated toward the anode by an acceleration voltage. When the electrons impact on the anode, the energy of the electrons is partly converted into X-ray beams. The X-ray beams emerge through a window provided for this purpose and are directed at an object to be examined or treated.

Rotating anodes may be used as anodes. The anodes rotate during the beam generation in order thus to counteract heating or to enable improved heat dissipation. Rotating anode X-ray tubes are a disposable part on account of the high performance requirements (e.g., in medical use). With respect to replacement parts, the state of a component is to be determined before the replacement parts fail in order to be able to undertake a replacement in good time. In addition to the vacuum seal and the electron emitter or cathode, the anode plate in X-ray tubes is one of the main disposable parts. As a result of the fluctuations in the thermal load, the anode surface is roughened, leading to a loss of radiation power. The loads may also manifest by melted areas and cracks forming on the anode. The X-ray dose power reduces as a result of these defects. Ultimately, the tube becomes unusable.

The speed, at which the wear of an X-ray tube progresses, depends on the type of X-ray recordings or on the loads occurring in the process. Thus, for example, high-power recordings lead to a significantly faster wear than X-ray recordings in fluoroscopy operation. Thus, the state of the utilized rotating anode is an important item of information that is to be determined in order to provide a timely replacement. The anode state or signs of wear are not accessible in the installed anode plate, even to measurement technology, because a direct measurement would be carried out in the vacuum housing of the emitter.

One option for monitoring the wear process is to subject the rotating anode X-ray tube to a standardized load program and, in the process, continuously measure the dose power throughout the service life. However, the dose-reduction measurement is very strongly determined by the trial design. A retrospective determination of the dose power as aging value of a used rotating anode X-ray tube is not possible or only possible with little accuracy. There is a need for additional methods for monitoring the state of an X-ray anode.

Thus, DD 268 892 A1 proposes that the depth of the cracks in the region of the focal path as a measure for the aging is established by abrasive measures (e.g., abrasive erosion), and the dose reduction is calculated from calibration curves. In this method, the crack pattern of the focal-path area is visually tracked by an epi-illumination microscope. This method is complicated and requires additional instruments.

### SUMMARY AND DESCRIPTION

It is desirable that less complicated methods that substantially use only the set of instruments that are already in place for the X-ray examination are provided.

The present embodiments may obviate one or more of the drawbacks or limitations in the related art. For example, an uncomplicated determination of the wear of an X-ray anode may be provided.

The angular dependence of radiation generated by an X-ray tube changes as the tube ages. A property for determining the age is assumed. The property is influenced by the angular dependence of the radiation generated by an X-ray anode. The angular dependence relates to the angle between the anode plate and the generated beams. This angular dependence is also referred to as heel effect. Thus, for example, the intensity of the radiation and the energy spectrum are dependent on this angle. The intensity may reduce on the anode side, and a shift to higher energies (e.g., beam hardening) may be determined. This inhomogeneity or angular dependence is dependent on the state of the anode plate. As wear increases, roughening takes place, and this reduces the angular dependence.

In one embodiment, at least one parameter that characterizes a property influenced by the angular dependence may be used. By way of example, this parameter may be the absolute or relative intensity in the angular region, in which there is significant attenuation. If the relative intensity is used, this may be related to a comparatively homogeneous region of the radiation or to the mean intensity. Alternatively, the considered property may be the anode-side hardening of the beams. By way of example, a measure or a quantitative parameter value is obtained by establishing the relative intensity of part of the energy spectrum. A filter may be used for this purpose, which, for example, filters out low-energy beams. The intensity of the transmitted radiation is then compared to the overall intensity. This ratio changes as a result of the anode-plate aging. When the relative intensity in one region of an energy spectrum is used, a stop may be used to restrict the measurements to the anode-side region, where the change in the beam hardness as a result of wear is strongest.

The at least one angle-dependent parameter is used to determine the aging or the wear. By way of example, a reference value is determined at the time, at which the tube is put into operation and later compared to values recorded for monitoring purposes. The change in this parameter may be corrected by the wear state of the anode or represents a measure for the wear state thereof.

Monitoring the aging state of the anode may be undertaken at specific service intervals that, for example, conform to the operating time. The operating time may have a flexible definition and may, for example, relate to the age of the anode (e.g., time passed since the production) in general terms. Alternatively, the operating time may denote the period of time, during which the anode was used for generating X-rays. A weighting of use times according to the type of use may also be provided.

### BRIEF DESCRIPTION OF THE DRAWINGS

FIG. 1 shows an X-ray tube;

FIG. 2 shows a rotating anode;

FIG. 3 shows one embodiment of a device for determining wear of an X-ray anode; and

FIG. 4 shows a flowchart for one embodiment of a method for determining wear of an X-ray anode.

### DETAILED DESCRIPTION OF THE DRAWINGS

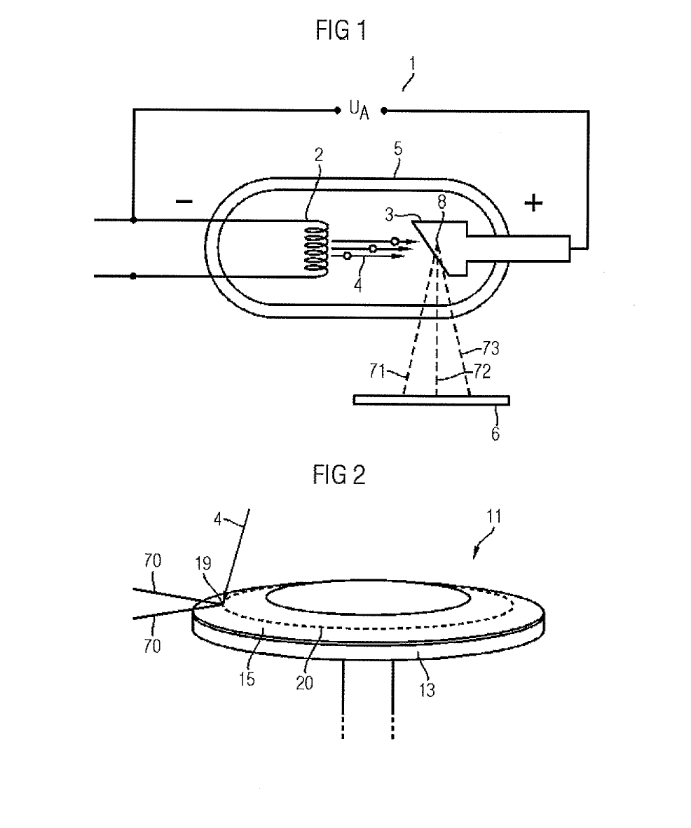

FIG. 1 shows an X-ray tube 1. The X-ray tube 1 is formed with a cathode 2 and an anode 3. During operation, the cathode 2 is heated such that electrons 4 are emitted. The electrons 4 are accelerated toward the anode 3 as a result of an applied anode or acceleration voltage U_{A}. X-ray beams are created during impact on the anode 3. The X-ray beams emerge from a vacuum housing 5 that surrounds the cathode 2 and anode 3 through a viewing window (not illustrated) and are detected by a detector 6. An object to be examined may be placed between the X-ray tube 1 and the detector 6 during use. The attenuation of the X-ray radiation through the object supplies information, from which object properties may be obtained.

The anode 3 may be a plate-shaped rotating anode. As a result of the rotation of the anode 3 during operation, the heat produced by the impacting electrons may be distributed in the anode plate during the rotation before the point is once again hit by the electron beam. A much higher power may be achieved. The configuration of a plate 11 of such a rotating anode is shown in FIG. 2. An emission layer 15 made of an emission material has been applied to a supporting part 13 of the rotating anode plate 11, from which emission material X-ray beams 70 are emitted under electron bombardment. An electron beam 4 is incident on the emission layer 15 at a focus 19. The heat generated at the focus 19 is distributed along a focal ring 20 as a result of the rotation of the rotating anode.

Beams 71, 72 and 73 produced by the X-ray tube 1 are shown in FIG. 1. The beams 71, 72 and 73 are emitted into different angular directions from the same focus. A distinction is made between two directions (e.g., the side of the cathode and the side of the anode). Beam 71 may be referred to as a cathode-side beam, and beam 73 may be referred to as an anode-side beam. The anode-side radiation includes a smaller angle with the anode surface than the other beams that are generated. The generated X-ray radiation is not completely homogeneous. This may be explained by the fact that the radiation is generated within the anode, and a path thereof passes through the anode before the vacuum is reached. A point 8 within the anode 1 has been drawn by way of example, with the three X-ray beams 71, 72 and 73 being created at the point 8. As a result of the angle of the anode surface or the anode plate, an anode-side beam passes along a longer path within the anode than a cathode-side beam. This passing over a longer path leads to two effects: 1) The overall intensity is attenuated to a greater extent as a result of absorption; and 2) beams with lower X-ray energy, for example, are absorbed more strongly, and so, the energy spectrum of the X-ray radiation on the anode side is shifted up to high energies (e.g., also referred to as beam hardening).

This anode-side change in the radiation may also be referred to as heel effect. The heel effect thus describes the angular dependence of the radiation of an electron beam on a target. The intensity reduces at smaller angles with respect to the anode surface as a result of the inherent absorption of the generated radiation. The inherent filtering leads to an angle-dependent spectrum of the emitted radiation. This effect may be unwanted and so, for example, filters designed for compensating this effect have been proposed in order to obtain a homogenizing effect for radiation (cf. US 2010/0098209 A1).

In one embodiment, this heel effect may be used for monitoring the anode aging or monitoring the anode wear. The intensity of the emitted radiation reduces with increasing roughness of the anode plate, which may be traced back to wear. If the emitted dose at the same scanning parameters is observed over the service life using a detector, a decreasing intensity is obtained with increasing roughness. An oncoming emitter breakdown may be deduced from empirical values.

In addition to the absolute radiation intensity, an increasing plate roughness also changes the spectral properties of the emitted radiation. While the absolute intensity over the operation of an X-ray instrument may be measured relatively imprecisely without external aids (e.g., an external dosimeter), a change in the spectrum may, for example, be measured very well via relative intensity by using a simple displaceable filter.

As a result of the heel effect, the spectrum of the emitted radiation depends on the observation angle on the anode surface. The spectral variation depending on the viewing angle on the anode plate reduces with increasing anode roughness (e.g., a smooth plate exhibits a relatively large variation of the spectrum over the anode angle. The spectra equalize with increasing roughness. If a decreasing spectral variation is observed, an increasing roughness may be directly inferred. An oncoming emitter breakdown may be deduced from empirical values.

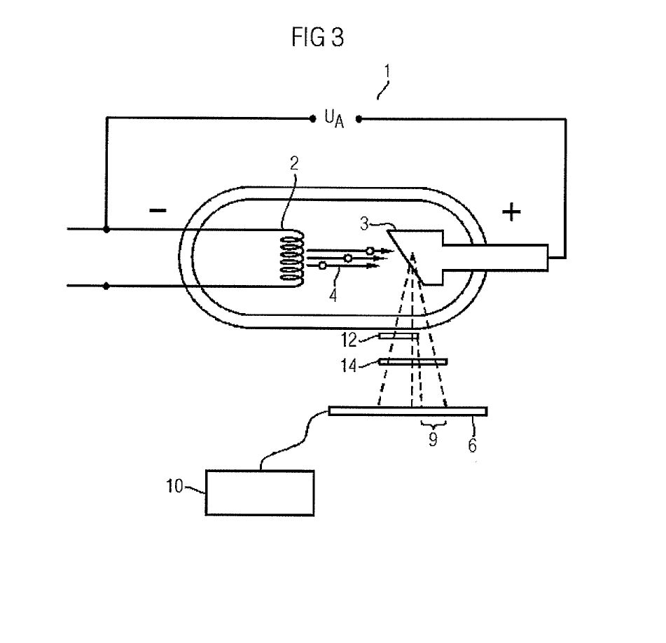

FIG. 3 is used to describe how an age or wear determination according to one embodiment may be carried out. Properties of the X-ray radiation in the region of heel effect (e.g., in the anode-side beam bundle) change in absolute terms and in comparison with the beam properties as a whole.

A measurement for an anode-side angular region is provided. Such a region is denoted by reference sign 9 in FIG. 3. A measurement for this region may be carried out using a spatially resolving detector. Alternatively, a stop 12 may be introduced in the beam path. Using the stop 12, beams outside of the angular region 9 are masked. The overall intensity or, for example, the intensity of a restricted energy range of the X-ray energy spectrum is determined for the region 9. The spectrum or energy range may, for example, be restricted using an energy-selective detector 6. Alternatively, a filter 14 that filters out low wavelengths is introduced. By way of example, such a filter may be made of aluminum or tin. The intensity measured in the region 9 is related to the overall intensity, and the aging state or the wear of the anode plate is deduced from the change in the relative intensity measured for the region 9. Additionally, the absolute intensity in the region 9 may be used as a criterion.

In one embodiment, the aging state may be determined from the change in the energy spectrum in the region 9. The measurement of the intensity for the region 9 for a portion of the energy spectrum is related to a measurement of the overall intensity of the part of the region 9. By way of example, two measurements are carried out for this purpose (e.g., once with a filter 14 and once without the filter 14). The aging state or the roughness of the anode plate is deduced from the relative intensity for the X-ray beams of the selected energy spectrum range. Test measurements may be carried out, and empirical values may be collected. The empirical values are, for example, recorded in the form of a table and made available. Statements with respect to the aging state as a result of such tables may thus be derived.

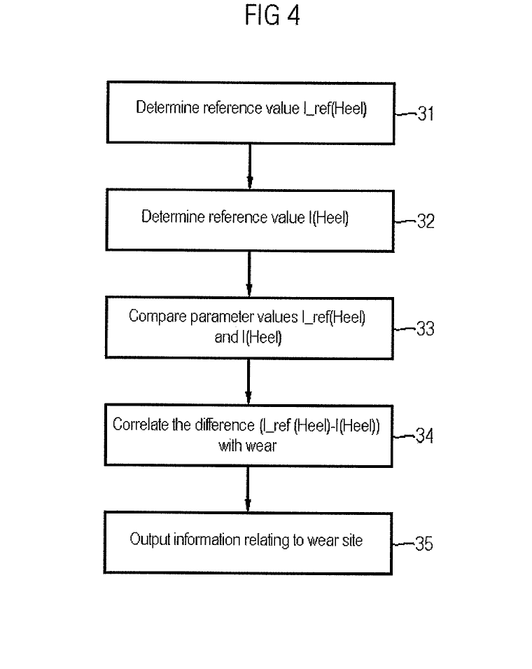

FIG. 4 shows the progress of an age determination according to one embodiment in a flowchart. In act 31, a reference value I_ref(Heel) is determined for the parameter (e.g., the relative intensity for high energies in an angular region influenced by the heel effect) used for determining the age. This reference value is determined for the new X-ray tube or for the X-ray tube without wear. Once the X-ray tube has been put into operation, a new value I(Heel) is determined for the parameter (act 32) according to the stipulation of monitoring intervals, which, for example, depend on the operating time. The measured parameter value I(Heel) is compared to the reference value I_ref(Heel) (act 33) with the aid of an evaluation device (e.g., reference sign 10 in FIG. 3; a processor). The difference is correlated with a wear state (act 34), for example, with the aid of a table that encodes empirical values. Information with respect to the wear state is output in act 35. In accordance with this information, the tube or the anode plate may be replaced.

The methods enable a nondestructive estimation of the state of the plate roughness. Many X-ray diagnostic imaging systems already include detectors, using which the established X-ray dose may be measured. For example, no further hardware is required for the methods.

In the case that the dose stability of the detector is not sufficient for observing the change over time, a determination of the age using spectral changes is more suitable. In this case, only relative and not absolute intensities may be measured. Many X-ray diagnostic imaging systems already have wide detectors, using which the anode may be measured at different angles. Many systems already have displaceable filters for variable hardening of the spectrum. These may be used for measuring the angle-dependent change in the system.

The invention is not restricted to the exemplary embodiments. Further embodiments and options may be obtained by a person skilled in the art by routine changes of the elements specified in the exemplary embodiments.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for determining wear of an X-ray anode having an anode plate, the method comprising:
determining a reference value for a parameter, the parameter characterizing a property influenced by the dependence of an angle between radiation generated by the X-ray anode and the anode plate;
determining, with a processor, a value for the parameter after a specific operating time of the X-ray anode;
comparing the determined value for the parameter with the reference value for the parameter; and
correlating a deviation of the determined value for the parameter from the reference value for the parameter with a wear state of the X-ray anode.

2. The method as claimed in claim 1, wherein the property relates to an intensity or an energy spectrum of the generated radiation.

3. The method as claimed in claim 2, wherein the parameter represents a measure for a relative change in the intensity of the generated radiation in an angular-range section of a beam bundle or a measure for a change relating to the energy spectrum.

4. The method as claimed in claim 3, wherein the parameter represents a measure for a relative radiation intensity of a portion of the energy spectrum.

5. The method as claimed in claim 4, further comprising routing a filter into a region of the beam bundle in order to measure the relative radiation intensity of the portion of the energy spectrum.

6. The method as claimed in claim 1, further comprising restricting radiation onto an anode-side region using a stop.

7. The method as claimed in claim 2, further comprising restricting radiation onto an anode-side region using a stop.

8. The method as claimed in claim 3, further comprising restricting radiation onto an anode-side region using a stop.

9. The method as claimed in claim 4, further comprising restricting radiation onto an anode-side region using a stop.

10. A device for determining wear of an X-ray anode having an anode plate, the device comprising:
a detector operable to record at least one measurement value; and
an evaluation device configured to:
establish a value for a parameter from the at least one measurement value, wherein the parameter characterizes a property influenced by the dependence of an angle between radiation generated by the X-ray anode and the anode plate;
compare the established value for the parameter with a reference value; and
correlate a deviation of the established value for the parameter from the reference value with a wear state of the X-ray anode.

11. The device as claimed in claim 10, wherein the property relates to an intensity or an energy spectrum of the generated radiation.

12. The device as claimed in claim 11, wherein the parameter represents a measure for a relative change in the intensity of the generated radiation in an angular-range section of a beam bundle or a measure for a change relating to the energy spectrum.

13. The device as claimed in claim 12, wherein the parameter represents a measure for a relative radiation intensity of a portion of the energy spectrum.

14. The device as claimed in claim 13, further comprising a filter that is routable into a region of the beam bundle in order to measure the relative radiation intensity of the portion of the energy spectrum.

15. The device as claimed in claim 10, further comprising a stop operable to restrict radiation onto an anode-side region.

16. The device as claimed in claim 10, further comprising a table for correlating the deviation of the parameter value from the reference value with the wear state of the X-ray anode.

17. The device as claimed in claim 11, further comprising a stop operable to restrict radiation onto an anode-side region.

18. The device as claimed in claim 14, further comprising a stop operable to restrict radiation onto an anode-side region.

19. The device as claimed in claim 11, further comprising a table for correlating the deviation of the parameter value from the reference value with the wear state of the X-ray anode.

20. The device as claimed in claim 14, further comprising a table for correlating the deviation of the parameter value from the reference value with the wear state of the X-ray anode.
